(19) United States
(12) Patent Application Publication
(10) Pub. No.: US 2021/0205756 A1
(43) Pub. Date: Jul. 8, 2021

(54) Exhaust stack Carbon Dioxide emissions conversion into Bulk Industrial Chemicals from the combustion of Fossil Fuels/Hydrocarbons or other Chemical/Biochemical processes

(71) Applicant: Richard J. Alescio, Bainbridge Island, WA (US)

(72) Inventor: Richard J. Alescio, Bainbridge Island, WA (US)

(21) Appl. No.: 16/602,968

(22) Filed: Jan. 7, 2020

(51) Int. Cl. B01D 53/73; B01D 53/00; B01D 53/62; B01D 53/14; B01D 53/75; B01D 53/79; B01D 46/00

(52) U.S. Cl. CPC B01D 53/73; B01D 53/002; B01D 53/62; B01D 53/1475; B01D 53/75; B01D 2259/124; B01D 46/00; B01D 2258/0233; B01D 2258/025; B01D 2258/0283; B01D 2256/22; B01D 53/79

(57) ABSTRACT

This patent relates to the conversion of the Carbon Dioxide (CO2) in exhaust stack emissions from the combustion of fossil fuels or other CO2 emitting processes into Bulk Chemicals used in multiple industries. The Process Block is comprised of:
Particulate Filter/Precipitator Unit, as required
Condenser/Exhaust Stack Heat Recovery Unit
Exhaust Gas' Pressure Blower Unit
Chemical Solution Holding Vessels
CO2 Reaction Units
Chemical Mixing Vessels
Process Pumps
Evaporator Train
Dry Bulk Chemical on site Temporary Storage prior to load out to Rail Cars or Semi Truck Bulk Trailer(s)
Process Accelerator Enhancement Technology, as required, and deemed feasible

### BACKGROUND

This Process Block approach to capturing Carbon Dioxide from Exhaust Stacks converts it into Dry Industrial Bulk Chemicals (Sodium Bicarbonate and Sodium Carbonate) on the site of the Emitting Exhaust Stack or at a Central Processing Facility located elsewhere.

The present process invention relates to an adaption of the original “Solvay Process” developed by Ernest J. Solvay in the late 1800's. This process made these two chemicals in bulk on an industrial scale. This process has been somewhat replaced by the mining of “Trona”, a naturally occurring related Salt of these Chemicals, which still must be dissolved, reconstituted, and dried. This present process invention Helps Solve an Excess World Wide Green House Gas (CO2) Emission Problem which is Significantly Contributing to Global Warming.

The Industrial and Commercial Demand for these two Chemicals continues to increase. In addition, there are Carbon Credits and Offsets which can be Generated, while not crippling the world economy, as we solve this aspect of the Green House Gas Emission Problem.

This process is well established from the past two centuries and does not require significant process development to perfect for each set of industrial applications:
Fossil Fuel Power Plants (coal, fuel oils, natural gas)
Cement Plants
Chemical Plants
Steel Mills and Blast Furnaces, Electric Arc Furnace
Aluminum Plants
Other Metals reduction processes

### BRIEF SUMMARY

It is an object of the present invention to:
Add this Process Block to each Exhaust Stack Emission Site, as practical, and ship Dry Solid Chemicals, in bulk form to customers. or
Divide the Process into two locations;
   CO2 Absorption at the Exhaust Stack site.
   Transport Aqueous Liquid with CO2 bound in a Chemical Salt to a Centralized Site for further processing into one of two Bulk Solids as previously stated.
Additional objects and advantages of this invention are apparent in descriptions following, referencing attached drawing(s).

### DESCRIPTION OF DRAWINGS

FIG. 1: A labeled process schematic block diagram indicating the input streams, output products, and their interrelated connections.

FIG. 2: A labeled process schematic block diagram indicating the input streams, output products, their interrelated connections, and equipped with a modified evaporator.

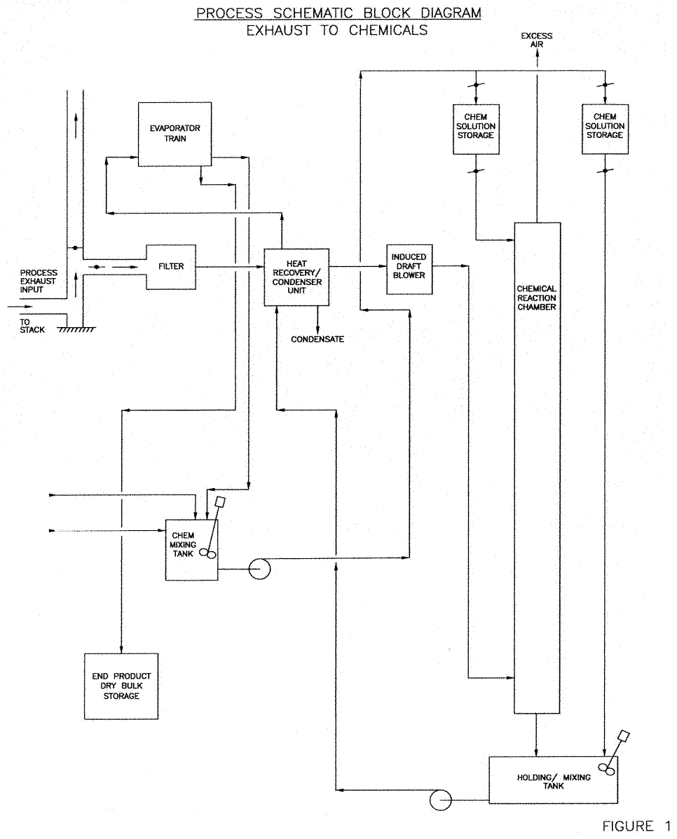

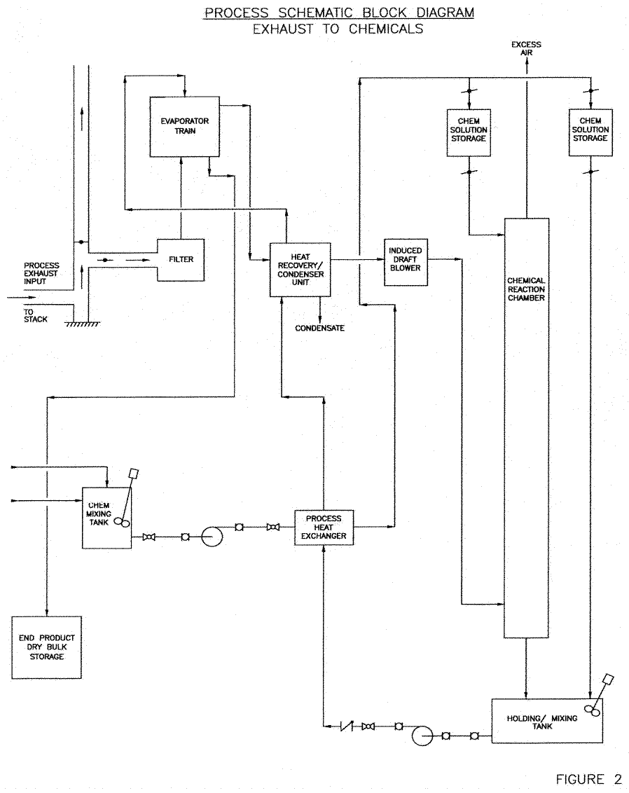

1. An add on process block for:
1. Capturing the CO2 from exhaust stacks in an aqueous liquid and processing it elsewhere into dry bulk chemicals for sale to existing Industrial and commercial customers (See FIG. 1 following).
2. Capturing the CO2 from exhaust stacks in an aqueous liquid and processing it on site into dry bulk chemicals for sale to existing Industrial and commercial customers (See FIG. 2 following).
